(19) United States
(12) Patent Application Publication
(10) Pub. No.: US 2024/0357334 A1
(43) Pub. Date: Oct. 24, 2024

(54) SHORT AREA INDICATION FOR PUBLIC WARNING SYSTEM

(71) Applicant: Telefonaktiebolaget LM Ericsson (publ), Stockholm (SE)

(72) Inventors: Mattias BERGSTRÖM, Sollentuna (SE); Helka-Liina MÄÄTTÄNEN, Espoo (FI)

(73) Assignee: Telefonaktiebolaget LM Ericsson (publ), Stockholm (SE)

(21) Appl. No.: 18/291,694

(22) PCT Filed: Jul. 22, 2022
(86) PCT No.: PCT/EP2022/070606

§ 371 Date: Jan. 24, 2024

Related U.S. Application Data
(60) Provisional application No. 63/225,660, filed on Jul. 26, 2021.

(51) Int. Cl. H04W 4/90; H04W 4/021; H04W 4/029; H04W 84/04

(52) U.S. Cl. CPC H04W 4/90; H04W 4/021; H04W 4/029; H04W 84/042

(57) ABSTRACT

A user equipment (UE) may receive an area indication transmitted by a network node. The area indication may identify an area to which a public warning system (PWS) message is applicable. The area indication may not include coordinates and/or shapes that define a geographical area to which the PWS message is applicable. The area indication may include a country indication that identifies a country to which the PWS message is applicable and/or a network indication that identifies a network (or part of a network) to which the PWS message is applicable. The UE may determine whether the UE is in the area to which the PWS message is applicable. Based on the determination, the UE may display or discard the PWS message.

### TECHNICAL FIELD

This disclosure relates to an area indication that identifies an area to which a public warning system (PWS) message is applicable and, in particular, to an area indication that is short relative to a geographical area configuration defined by coordinates and/or shapes.

### BACKGROUND

### 1.1 Non-Terrestrial Networks (NTNs)

In Third Generation Partnership Project (3GPP) Release 15, a release of the 5^{th} Generation (5G) system (5GS) was described. This radio access technology is intended to serve use cases such as enhanced mobile broadband (eMBB), ultra-reliable and low latency communication (URLLC) and massive machine type communication (mMTC). 5G includes the New Radio (NR) access stratum interface and the 5G Core Network (5GC). The NR physical and higher layers are reusing parts of the Long Term Evolution (LTE) specification/standard and also introduce new components for new use cases.

In 3GPP Release 15, 3GPP described preparing NR for operation in a Non-Terrestrial Network (NTN). Research was performed within the study item “NR to support Non-Terrestrial Networks” and resulted in Technical Report (TR) 38.811. In 3GPP Release 16, research to prepare NR for operation in an NTN network continued with the study item “Solutions for NR to support Non-Terrestrial Network” and resulted in TR 38.821. In parallel, the interest to adapt LTE for operation in NTN is growing, and 3GPP is considering introducing support for NTN in both LTE and NR in Release 17.

### 1.1.1 Satellite Communications

FIG. 1 illustrates an example architecture of a satellite radio access network 100. In the example illustrated in FIG. 1, the satellite radio access network 100 includes bent pipe transponders. As shown in FIG. 1, a satellite radio access network 100 may include a satellite 106, a gateway 108, a feeder link, and an access link. A satellite radio access network 100 may include one or more of the following components: (i) a satellite 106 that refers to a space-borne platform; (ii) an earth-based gateway 108 that connects the satellite 106 to a network node 104 (e.g. a base station or a core network, depending on the choice of architecture); (iii) a feeder link that refers to the link between a gateway 108 and a satellite 106; and/or (iv) an access link that refers to the link between a satellite 106 and a user equipment (UE) 102 (e.g., a wireless device).

Depending on the orbit altitude, a satellite 106 may be categorized as a low earth orbit (LEO) satellite, a medium earth orbit (MEO) satellite, or a geostationary earth orbit (GEO) satellite. An LEO satellite may have heights ranging from 250-1,500 km, with orbital periods ranging from 90-120 minutes. An MEO satellite may have heights ranging from 5,000-25,000 km, with orbital periods ranging from 3-15 hours. A GEO satellite may have a height at about 35,786 km, with an orbital period of 24 hours. The orbit height means that satellite systems are characterized by a path loss that is significantly higher than what is expected in terrestrial networks. To overcome the path loss, the access and feeder links are often operated in line of sight conditions, and that the UE 102 may be equipped with an antenna offering high beam directivity.

A communication satellite 106 may generate several beams over a given area. The footprint of a beam is usually in an elliptic shape, which has been traditionally considered as a cell. The footprint of a beam is also often referred to as a spotbeam 110. The spotbeam 110 may move over the earth surface with the satellite movement or may be earth fixed with some beam pointing mechanism used by the satellite 106 to compensate for its motion. The size of a spotbeam 110 depends on the system design. The size of a spotbeam 110 may range from tens of kilometers to a few thousands of kilometers.

The NTN spotbeams 110 may, in comparison to the beams observed in a terrestrial network, be very wide and cover an area outside of the area defined by the served cell. Spotbeams 110 covering adjacent cells will overlap and cause significant levels of intercell interference. To overcome the large levels of interference, a typical approach is a NTN to configure different cells with different carrier frequencies and polarization modes.

### 1.2 Public Warning System (PWS)

NR and LTE systems support providing Public Warning System (PWS) messages to users, for example indications of a fire or some other danger of which the public should be made aware.

Two types of PWS indications have been specified for NR. Earthquake and Tsunami Warning System (ETWS) and Commercial Mobile Alert System (CMAS). These features are that the network can broadcast a message in a system information block. The message may be long and need to be segmented o several segments, and the network sends these segments in a sequence in system information. The Radio Resource Control (RRC) entity which receives those segments will assemble the segments and forward the message to upper layers.

The network can provide an area-configuration associated to a PWS message. That area-configuration is a set of coordinates, shape, etc. If such area is provided, the UE will use a positioning-device (e.g. a Global Positioning System (GPS)) to determine if the UE is within that area or not and only display the PWS message if the UE is within that area.

### SUMMARY

Certain challenges presently exist. For instance, in a Non-Terrestrial Network (NTN), cells may cover a very large area (e.g., large enough to be covering multiple countries). The large covered areas means that, in the case of a Public Warning System (PWS) message applicable for one country, user equipment (UEs) in one or more other countries (e.g., one or more countries that are not the country to which the PWS is applicable) may receive and act on that PWS message, which may be undesirable.

As described above, in existing Long Term Evolution (LTE) and New Radio (NR) specifications, it is possible that the network provides a geographical area configuration associated with a PWS message. That geographical area configuration is defined by a set of coordinates/shapes etc. However, the geographical area configuration may be so large that it may in some cases need to be segmented to be able to be sent to the UE in system information. It may not be feasible to use the existing geographical area configuration for a PWS message to indicate that the PWS message applies only to a certain country. The reason is that, to describe a very large region, the geographical area configuration would have a message size that is too large. For example, if an NTN-cell covers two countries, it may be too costly in terms of signaling overhead to use the existing geographical area configuration defined by a set of coordinates/shapes to indicate that the PWS message is only applicable to one of the countries.

Aspects of the invention may overcome one or more of the problems by, instead of relying on a geographical area configuration defined by a set of coordinates/shapes to indicate the area to which the PWS message applies, using an area indication to indicate that the PWS message applies only to a certain area. In some aspects, the area indication may include a country indication to indicate that the PWS message applies only to a certain country. In some aspects, the area indication may additionally or alternatively include a network indication to indicate that the PWS message applies only to a certain network (and/or to a part of the network). In some aspects, the network indication may include, for example and without limitation, a public land mobile network (PLMN) and/or a tracking area code (TAC).

Aspects of the invention may provide the advantage of an area indication that has a small size relative to the size of a geographical area configuration is defined by a set of coordinates/shapes. In some aspects, the relatively small area indication may indicate that a PWS message applies only to a certain county, a certain network, and/or a certain part of a network without excessive signaling overhead. In some aspects, the small size of the area indication may enable a PWS message, which itself can be large, to be provided to the UE in same system information (SI) message as the area indication that indicates where the PWS message is valid.

Aspects of the invention may additionally or alternatively provide the advantage of an area indication (e.g., country indication) that can be defined or used in the same context as other country specific aspects of NTN that may or may not be visible in SI.

One aspect of the invention may provide a method performed by a user equipment (UE). The method may include receiving an area indication transmitted by a network node. The area indication may identify an area to which a public warning system (PWS) message is applicable. The area indication may not include coordinates and/or shapes that define a geographical area to which the PWS message is applicable. The method may include determining whether the UE is in the area to which the PWS message is applicable.

In some aspects, the area indication may be an octet string. In some aspects, the PWS message may be an Earthquake and Tsunami Warning System (ETWS) message or a Commercial Mobile Alert System (CMAS) message. In some aspects, the area indication may be smaller than a geographical area configuration defined by a set of coordinates and/or shapes.

In some aspects, the area indication may include a county indication that identifies a country to which the PWS message is applicable, and determining whether the UE is in the area to which the PWS message is applicable may include determining whether the UE is in the country to which the PWS message is applicable. In some aspects, the country indication may be a country code.

In some aspects, the area indication may include a network indication that identifies a network or a part of a network to which the PWS message is applicable, and determining whether the UE is in the area to which the PWS message is applicable may include determining whether the UE is in the network or the part of the network to which the PWS message is applicable. In some aspects, the network indication may identify one or more public land mobile networks (PLMNs) to which the PWS message is applicable, and determining whether the UE is in the area to which the PWS message is applicable may include determining whether the UE is in the one or more PLMNs to which the PWS message is applicable. In some aspects, the network indication may identify one or more tracking areas, and determining whether the UE is in the area to which the PWS message is applicable may include determining whether the UE is in the one or more tracking areas to which the PWS message is applicable.

In some aspects, the network indication may include a set of one or more cell identifiers (IDs) that identify one or more cells to which the PWS message is applicable, and determining whether the UE is in the area to which the PWS message is applicable may include determining whether the UE is in one of the one or more cells to which the PWS message is applicable. In some aspects, the network indication may include a set of one or more physical cell IDs (PCIs) that identify one or more physical cells to which the PWS message is applicable, and determining whether the UE is in the area to which the PWS message is applicable may include determining whether the UE is in one of the one or more physical cells to which the PWS message is applicable.

In some aspects, the method may further include, if the UE is determined to be in the area to which the PWS message is applicable, displaying the PWS message. In some aspects, the method may further include, if the UE is determined to not be in the area to which the PWS message is applicable, discarding the PWS message. In some aspects, discarding the PWS message may include not displaying the PWS message.

In some aspects, the area indication may be received in a Radio Resource Control (RRC) message. In some aspects, the area indication may be received in a system information block (SIB) (e.g., SIB6, SIB7, or SIB8) of the RRC message. In some aspects, the complete area indication may be received in a single system information block (SIB) (e.g., SIB6, SIB7, or SIB8) of the RRC message.

In some aspects, the method may further include receiving the PWS message. In some aspects, receiving the PWS message may include receiving the PWS message or a segment of the PWS message in a system information block (SIB) of a Radio Resource Control (RRC) message, and the SIB may further include the area indication. In some aspects, the area indication may be separate from the PWS message.

In some aspects, an access stratum (AS) of the UE may determine whether the UE is in the area to which the PWS message is applicable. In some aspects, the method may further include, if the AS determines the UE to be in the area to which the PWS message is applicable, the AS forwarding the PWS message to an upper layer (e.g., a non-access stratum (NAS)) of the UE. In some aspects, the method may further include, if the AS determines the UE to not be in the area to which the PWS message is applicable, the AS does not forward the PWS message to an upper layer (e.g., a non-access stratum (NAS)) of the UE. In some aspects, the AS may be in an RRC layer of the UE.

In some aspects, the method may further include an access stratum (AS) of the UE forwarding the area indication and the PWS message to an upper layer (e.g., a non-access stratum (NAS)) of the UE, and the upper layer may determine whether the UE is in the area to which the PWS message is applicable. In some aspects, the AS may be in an RRC layer of the UE.

In some aspects, the area indication may be within the PWS message. In some aspects, the method may further include an access stratum (AS) of the UE forwarding the PWS message including the area indication to an upper layer (e.g., a non-access stratum (NAS)) of the UE, and the upper layer may determine whether the UE is in the area to which the PWS message is applicable.

In some aspects, the method may further include receiving PWS message segments and using the PWS message segments to assemble the PWS message.

Another aspect of the invention may provide a computer program including instructions which, when executed by processing circuitry of a user equipment (UE), cause the UE to perform the method of any of the aspects above. Yet another aspect of the invention may provide a carrier containing the computer program, wherein the carrier is one of an electronic signal, an optical signal, a radio signal, and a computer readable storage medium.

Still another aspect of the invention may provide a user equipment (UE). The UE may include processing circuitry. The UE may include a memory containing instructions executable by the processing circuitry. The UE may be configured to perform the method of any of the aspects above.

Yet another aspect of the invention may provide a user equipment (UE). The UE may be configured to receive an area indication transmitted by a network node. The area indication may identify an area to which a public warning system (PWS) message is applicable. The area indication may not include coordinates and/or shapes that define a geographical area to which the PWS message is applicable. The UE may be configured to determine whether the UE is in the area to which the PWS message is applicable.

In some aspects, the UE may be further configured to perform the method of any of the aspects above.

Another aspect of the invention may provide a method performed by a network node (e.g., gNB, eNB, base station, or access node). The method may include transmitting a public warning system (PWS) message. The method may include transmitting an area indication that identifies an area to which a PWS message is applicable. The area indication may not include coordinates and/or shapes that define a geographical area to which the PWS message is applicable.

In some aspects, the area indication may be an octet string. In some aspects, the PWS message may be an Earthquake and Tsunami Warning System (ETWS) message or a Commercial Mobile Alert System (CMAS) message. In some aspects, the area indication may be smaller than a geographical area configuration defined by a set of coordinates and/or shapes.

In some aspects, the area indication may include a county indication that identifies a country to which the PWS message is applicable. In some aspects, the country indication may be a country code.

In some aspects, the area indication may include a network indication that identifies a network or a part of a network to which the PWS message is applicable. In some aspects, the network indication may identify one or more public land mobile networks (PLMNs) to which the PWS message is applicable. In some aspects, the network indication may identify one or more tracking areas.

In some aspects, the network indication may include a set of one or more cell identifiers (IDs) that identify one or more cells to which the PWS message is applicable. In some aspects, the network indication may include a set of one or more physical cell IDs (PCIs) that identify one or more physical cells to which the PWS message is applicable.

In some aspects, the area indication may be transmitted in a Radio Resource Control (RRC) message. In some aspects, the area indication may be transmitted in a system information block (SIB) (e.g., SIB6, SIB7, or SIB8) of the RRC message. In some aspects, the complete area indication may be transmitted in a single system information block (SIB) (e.g., SIB6, SIB7, or SIB8) of the RRC message.

In some aspects, transmitting the PWS message may include transmitting the PWS message or a segment of the PWS message in a system information block (SIB) of a Radio Resource Control (RRC) message, and the SIB may further include the area indication.

In some aspects, the area indication may be separate from the PWS message. In some aspects, the area indication may be within the PWS message.

In some aspects, transmitting the PWS message may include transmitting PWS message segments.

Still another aspect of the invention may provide a computer program including instructions which, when executed by processing circuitry of a network node (e.g., gNB, eNB, base station, or access node), cause the network node to perform the method of the aspects above. Yet another aspect of the invention may provide a carrier containing the computer program. The carrier may be one of an electronic signal, an optical signal, a radio signal, and a computer readable storage medium.

Still another aspect of the invention may provide a network node (e.g., gNB, eNB, base station, or access node). The network node may include processing circuitry. The network node may include a memory containing instructions executable by the processing circuitry. The network node may be configured to perform the method of any of the aspects above.

Another aspect of the invention may provide a network node (e.g., gNB, eNB, base station, or access node). The network node may be configured to transmit a public warning system (PWS) message. The network node may be configured to transmit an area indication that identifies an area to which a PWS message is applicable. The network node may not include coordinates and/or shapes that define a geographical area to which the PWS message is applicable.

In some aspects, the network node may be further configured to perform the method of any of the aspects above.

Still another aspect of the invention may provide any combination of the embodiments set forth above.

### BRIEF DESCRIPTION OF THE DRAWINGS

The accompanying drawings, which are incorporated herein and form part of the specification, illustrate various embodiments.

FIG. 1 illustrates an example architecture of a satellite radio access network

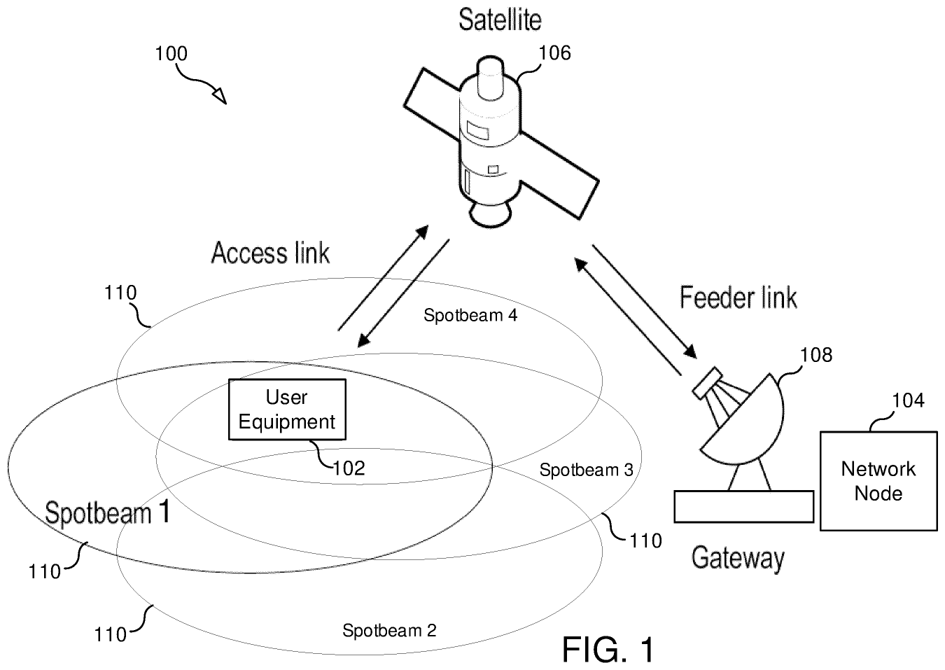

FIG. 2 is a flowchart illustrating a process according to some embodiments.

FIG. 3 is a flowchart illustrating a process according to some embodiments.

FIG. 4 is a block diagram of a UE according to some embodiments.

FIG. 5 is a block diagram of a network node according to some embodiments.

### DETAILED DESCRIPTION

In this application, the term “user equipment” or “UE” may refer to any type of wireless device communicating with a network node and/or with another UE in a cellular or mobile communication system. Examples of UEs include, but are not limited to, a target device, a device to device (D2D) UE, a vehicular to vehicular (V2V), a machine type UE, an machine type communication (MTC) UE, a UE capable of machine to machine (M2M) communication, a personal digital assistant (PDA), a tablet, a mobile terminal(s), a smart phone, laptop embedded equipment (LEE), laptop mounted equipment (LME), and universal serial bus (USB) dongles.

In this application, the term “network” may be used to refer to a network node, which may be a gNodeB (gNB) (e.g., in an NR-based NTN), but which may also be an evolved Node B (eNB) (e.g., in an LTE-based NTN) or a base station or an access point in another type of network, or any other network node with the ability to communicate with a UE. Examples of network nodes include, but are not limited to, a NodeB, a base station (BS), a multi-standard radio (MSR) radio node such as a MSR BS, an eNodeB, a gNodeB, a Master eNB (MeNB), a Secondary eNB (SeNB), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, remote radio unit (RRU), remote radio head (RRH), nodes in distributed antenna system (DAS), core network node (e.g. mobile switching center (MSC), mobile management entity (MME), etc.), operation and management (O&M), operation support systems (OSS), self-organizing network (SON), positioning node (e.g. evolved serving mobile location centre (E-SMLC)).

In existing LTE and NR specifications, it is possible that the network provides a geographical area configuration associated to a Public Warning System (PWS) message. That geographical area configuration is defined by a certain set of coordinates/shapes etc. The PWS message is considered applicable for UEs within that geographical area. The geographical area configuration may be so large it may need to be segmented in order to be able to be sent to the UE in system information (SI).

Aspects of the present invention may provide relatively lightweight approaches to providing an indication of where a PWS message is applicable. These lightweight approaches may be beneficial, for example, in Non-Terrestrial Network (NTN) scenarios. In some aspects, the area indication may include a country indication, a network indication, and/or an indication of a part of a network.

### 2.1 Country Indication

In some aspects, a network node 104 of a network (e.g., a satellite radio access network 100) may use a country indication to indicate a country to which a PWS message is applicable. The country indication may, for example and without limitation, be an octet string indicating a country-code (e.g., “SE” or “FI,” which may be mapped to Sweden and Finland, respectively). In some aspects, the network node 104 may transmit the country indication (e.g., in SI and/or in a PWS message).

In some aspects, a UE 102 may receive a country indication transmitted by a network node 104. In some aspects, the UE 102 may determine which country the UE 102 is in and use the country indication to determine for which country the PWS message is applicable. In some aspects, if the UE 102 determines the UE 102 to be in the country for which the PWS message is applicable, the UE 102 may consider the PWS message to be applicable for the UE 102 and take appropriate actions (e.g., displaying the PWS message to the user of the UE 102). In some aspects, if the UE determines the UE 102 to not be in the country for which the PWS message is applicable, the UE 102 may consider the PWS message to be not applicable for the UE 102, and the UE 102 may discard PWS message (and not display the PWS message to the user of the UE 102).

In some aspects, the decision on whether to display or discard a PWS message may be performed in the access stratum (AS) of the UE 102, for example in the Radio Resource Control (RRC) layer. An example implementation of RRC, which addresses Earthquake and Tsunami Warning System (ETWS) and Commercial Mobile Alert System (CMAS) PWS indications, is provided below with underlining to show changes.

### 5.2.2.4.7 Actions Upon Reception of SIB6

Upon receiving the SIB6 the UE shall:
1>if countryIndication is included and matches the country which the UE is in; or
1>if countryIndication is not included:
   2>forward the received warningType, messageIdentifier and serialNumber to upper layers;
      SIB6
         SIB6 contains an ETWS primary notification.

### SIB6 Information Element

| -- ASN1START | |
|---|---|
| -- TAG-SIB6-START | |
| SIB6 ::= | SEQUENCE { |
| messageIdentifier | BIT STRING (SIZE (16)), |
| serialNumber | BIT STRING (SIZE (16)), |
| warningType | OCTET STRING (SIZE (2)), |
| lateNonCriticalExtension | OCTET STRING |

```
OPTIONAL,
    ...,
    countryIndication OCTET STRING
}
-- TAG-SIB6-STOP
-- ASN1STOP
```

SIB6 field descriptions

messageIdentifier
Identifies the source and type of ETWS notification.
countryIndication
Identifies the country of ETWS notification.
serialNumber
Identifies variations of an ETWS notification.
warningType
Identifies the warning type of the ETWS primary notification and provides information on
emergency user alert and UE popup.

### 5.2.2.4.8 Actions Upon Reception of SIB7

Upon receiving the SIB7 the UE shall:
1>if countryIndication is included and matches the country which the UE is in; or
1>if countryIndication is not included:
   2>if there is no current value for messageIdentifier and serialNumber for SIB7; or
   2>if either the received value of messageIdentifier or of serialNumber, or of both messageIdentifier and serialNumber are different from the current values of messageIdentifier and serialNumber for SIB7:
      3>use the received values of messageIdentifier and serialNumber for SIB7 as the current values of messageIdentifier and serialNumber for SIB7;
      3>discard any previously buffered warningMessageSegment;
      3>if all segments of a warning message have been received:
         4>assemble the warning message from the received warningMessageSegment(s);
         4>forward the received warning message, messageIdentifier, serialNumber and dataCodingScheme to upper layers;
         4>stop reception of SIB7;
         4>discard the current values of messageIdentifier and serialNumber for SIB7;
      3>else:
         4>store the received warningMessageSegment;
         4>continue reception of SIB7;
   2>else if all segments of a warning message have been received:
      3>assemble the warning message from the received warningMessageSegment(s);
      3>forward the received complete warning message, messageIdentifier, serialNumber and dataCodingScheme to upper layers;
      3>stop reception of SIB7;
      3>discard the current values of messageIdentifier and serialNumber for SIB7;
   2>else:
      3>store the received warningMessageSegment;
      3>continue reception of SIB7;
         The UE should discard any stored warningMessageSegment and the current value of messageIdentifier and serialNumber for SIB7 if the complete warning message has not been assembled within a period of 3 hours.
SIB7
   SIB7 contains an ETWS secondary notification.

### SIB7 Information Element

-- ASN1START
-- TAG-SIB7-START

| | |
|---|---|
| SIB7 ::= | SEQUENCE { |
| messageIdentifier | BIT STRING (SIZE (16)), |
| serialNumber | BIT STRING (SIZE (16)), |
| warningMessageSegmentType | ENUMERATED {notLastSegment, lastSegment}, |
| warningMessageSegmentNumber | INTEGER (0..63), |
| warningMessageSegment | OCTET STRING, |
| dataCodingScheme | OCTET STRING (SIZE (1)) |

OPTIONAL, -- Cond Segment1

| | |
|---|---|
| lateNonCriticalExtension | OCTET STRING |

```
OPTIONAL,
    ...,
    countryIndication OCTET STRING
}
-- TAG-SIB7-STOP
-- ASN1STOP
```

SIB7 field descriptions
dataCodingScheme
Identifies the alphabet/coding and the language applied variations of an ETWS notification.
messageIdentifier
Identifies the source and type of ETWS notification.
countryIndication
Identifies the country of ETWS notification.
serialNumber
Identifies variations of an ETWS notification.
warningMessageSegment
Carries a segment of the Warning Message Contents IE.
warningMessageSegmentNumber
Segment number of the ETWS warning message segment contained in the SIB. A segment
number of zero corresponds to the first segment, A segment number of one corresponds to
the second segment, and so on.
warningMessageSegmentType
Indicates whether the included ETWS warning message segment is the last segment or not.

| Conditional Presence | Explanation |
|---|---|
| Segment1 | The field is mandatory present in the first segment of SIB7, |
| | otherwise it is absent. |

### 5.2.2.4.9 Actions Upon Reception of SIB8

Upon receiving the SIB8 the UE shall:
1>if countryIndication is included and matches the country which the UE is in; or
1>if countryIndication is not included:
   2>if the SIB8 contains a complete warning message and the complete geographical area coordinates (if any):
      3>forward the received warning message, messageIdentifier, serialNumber, dataCodingScheme and the geographical area coordinates (if any) to upper layers;
      3>continue reception of SIB8;
   2>else:
      3>if the received values of messageIdentifier and serialNumber are the same (each value is the same) as a pair for which a warning message and the geographical area coordinates (if any) are currently being assembled:
         4>store the received warningMessageSegment;
         4>store the received warningAreaCoordinatesSegment (if any);
         4>if all segments of a warning message and geographical area coordinates (if any) have been received:
         5>assemble the warning message from the received warningMessageSegment;
         5>assemble the geographical area coordinates from the received warningAreaCoordinatesSegment (if any);
         5>forward the received warning message, messageIdentifier, serialNumber, dataCodingScheme and geographical area coordinates (if any) to upper layers;
         5>stop assembling a warning message and geographical area coordinates (if any) for this messageIdentifier and serialNumber and delete all stored information held for it;
         4>continue reception of SIB8;
      3>else if the received values of messageIdentifier and/or serialNumber are not the same as any of the pairs for which a warning message is currently being assembled:
         4>start assembling a warning message for this messageIdentifier and serialNumber pair;
         4>start assembling the geographical area coordinates (if any) for this messageIdentifier and serialNumber pair;
         4>store the received warningMessageSegment;
         4>store the received warningAreaCoordinatesSegment (if any);
         4>continue reception of SIB8;
            The UE should discard warningMessageSegment and warningAreaCoordinatesSegment (if any) and the associated values of messageIdentifier and serialNumber for SIB8 if the complete warning message and the geographical area coordinates (if any) have not been assembled within a period of 3 hours.
NOTE: The number of warning messages that a UE can re-assemble simultaneously is a function of UE implementation.
   SIB8
      SIB8 contains a CMAS notification.

### SIB8 Information Element

-- ASN1START
-- TAG-SIB8-START

| | |
|---|---|
| SIB8 ::= | SEQUENCE { |
| messageIdentifier | BIT STRING (SIZE (16)), |
| serialNumber | BIT STRING (SIZE (16)), |
| warningMessageSegmentType | ENUMERATED {notLastSegment, lastSegment}, |
| warningMessageSegmentNumber | INTEGER (0..63), |
| warningMessageSegment | OCTET STRING, |
| dataCodingScheme | OCTET STRING (SIZE (1)) |

OPTIONAL, -- Cond Segment1

| | |
|---|---|
| warningAreaCoordinatesSegment | OCTET STRING |

OPTIONAL, -- Need R

| | |
|---|---|
| lateNonCriticalExtension | OCTET STRING |

```
OPTIONAL,
    ...,
    countryIndication OCTET STRING
}
-- TAG-SIB8-STOP
-- ASN1STOP
```

SIB8 field descriptions
dataCodingScheme
Identifies the alphabet/coding and the language applied variations of a CMAS notification.
messageIdentifier
Identifies the source and type of CMAS notification.
countryIndication
Identifies the country of CMAS notification.
serialNumber
Identifies variations of a CMAS notification.
warningAreaCoordinatesSegment
If present, carries a segment, with one or more octets, of the geographical area where the
CMAS warning message is valid as defined in [28]. The first octet of the first
warningAreaCoordinatesSegment is equivalent to the first octet of Warning Area
Coordinates IE defined in and encoded according to TS 23.041 [29] and so on.
warningMessageSegment
Carries a segment, with one or more octets, of the Warning Message Contents IE defined in
TS 38.413 [42]. The first octet of the Warning Message Contents IE is equivalent to the
first octet of the CB data IE defined in and encoded according to TS 23.041 [29], clause
9.4.2.2.5, and so on.
warningMessageSegmentNumber
Segment number of the CMAS warning message segment contained in the SIB. A segment
number of zero corresponds to the first segment, one corresponds to the second segment,
and so on. If warning area coordinates are provided for the warning message, then this field
applies to both warning message segment and warning area coordinates segment.
warningMessageSegmentType
Indicates whether the included CMAS warning message segment is the last segment or not.
If warning area coordinates are provided for the warning message, then this field applies to
both warning message segment and warning area coordinates segment.

| Conditional Presence | Explanation |
|---|---|
| Segment1 | The field is mandatory present in the first segment of SIB8, |
| | otherwise it is absent. |

In some alternative aspects, the decision on whether to display or discard a PWS message may be performed in the non-access stratum (NAS) of the UE 102. In some aspects, the decision in the NAS may rely on that the AS of the UE 102 forwarding the country indication to the NAS. In some aspects, the NAS may determine the country in which the UE 102 is and compare the determined county with the country indication of the PWS message.

In some aspects, the decision on whether to display or discard a PWS message may be performed in the access stratum (AS) of the UE 102, for example in the RRC layer. An example implementation of RRC, which addresses ETWS and CMAS PWS indications, is provided below with underlining to show changes.

### 5.2.2.4.7 Actions Upon Reception of SIB6

Upon receiving the SIB6 the UE shall:
1>forward the received warningType, messageIdentifier, countryIndication (if any) and serialNumber to upper layers;
   SIB6
      SIB6 contains an ETWS primary notification.

### SIB6 Information Element

| -- ASN1START | |
|---|---|
| -- TAG-SIB6-START | |
| SIB6 ::= | SEQUENCE { |
| messageIdentifier | BIT STRING (SIZE (16)), |
| serialNumber | BIT STRING (SIZE (16)), |
| warningType | OCTET STRING (SIZE (2)), |
| lateNonCriticalExtension | OCTET STRING |

```
OPTIONAL,
    ...,
    countryIndication OCTET STRING
}
-- TAG-SIB6-STOP
-- ASN1STOP
```

SIB6 field descriptions

messageIdentifier
Identifies the source and type of ETWS notification.
countryIndication
Identifies the country of ETWS notification.
serialNumber
Identifies variations of an ETWS notification.
warningType
Identifies the warning type of the ETWS primary notification and provides information on
emergency user alert and UE popup.

### 5.2.2.4.8 Actions Upon Reception of SIB7

Upon receiving the SIB7 the UE shall:
1>if there is no current value for messageIdentifier and serialNumber for SIB7; or
1>if either the received value of messageIdentifier or of serialNumber, or of both messageIdentifier and serialNumber are different from the current values of messageIdentifier and serialNumber for SIB7:
   2>use the received values of messageIdentifier and serialNumber for SIB7 as the current values of messageIdentifier and serialNumber for SIB7;
   2>discard any previously buffered warningMessageSegment;
   2>if all segments of a warning message have been received:
      3>assemble the warning message from the received warningMessageSegment(s);
      3>forward the received warning message, messageIdentifier, serialNumber and dataCodingScheme to upper layers;
      3>stop reception of SIB7;
      3>discard the current values of messageIdentifier and serialNumber for SIB7;
   2>else:
      3>store the received warningMessageSegment;
      3>continue reception of SIB7;
1>else if all segments of a warning message have been received:
   2>assemble the warning message from the received warningMessageSegment(s);
   2>forward the received complete warning message, messageIdentifier, serialNumber and dataCodingScheme, countryIndication (if any) to upper layers;
   2>stop reception of SIB7;
   2>discard the current values of messageIdentifier and serialNumber for SIB7;
1>else:
   2>store the received warningMessageSegment;
   2>continue reception of SIB7;
      The UE should discard any stored warningMessageSegment and the current value of messageIdentifier and serialNumber for SIB7 if the complete warning message has not been assembled within a period of 3 hours.
SIB7
   SIB7 contains an ETWS secondary notification.

### SIB7 Information Element

-- ASN1START
-- TAG-SIB7-START

| SIB7 ::= | SEQUENCE { | |
|---|---|---|
| messageIdentifier | BIT STRING (SIZE (16)), | |
| serialNumber | BIT STRING (SIZE (16)), | |
| warningMessageSegmentType | ENUMERATED {notLastSegment, lastSegment}, | |
| warningMessageSegmentNumber | INTEGER (0..63), | |
| warningMessageSegment | OCTET STRING, | |
| dataCodingScheme | OCTET STRING (SIZE (1)) | OPTIONAL, -- |

Cond Segment1

| | | |
|---|---|---|
| lateNonCriticalExtension | OCTET STRING | OPTIONAL, |

```
    ...,
    countryIndication OCTET STRING
}
-- TAG-SIB7-STOP
-- ASN1STOP
```

SIB7 field descriptions
dataCodingScheme
Identifies the alphabet/coding and the language applied variations of an ETWS notification.
messageIdentifier
Identifies the source and type of ETWS notification.
serialNumber
Identifies variations of an ETWS notification.
countryIndication
Identifies the country of ETWS notification.
warningMessageSegment
Carries a segment of the Warning Message Contents IE.
warningMessageSegmentNumber
Segment number of the ETWS warning message segment contained in the SIB. A segment
number of zero corresponds to the first segment, A segment number of one corresponds to
the second segment, and so on.
warningMessageSegmentType
Indicates whether the included ETWS warning message segment is the last segment or not.

| Conditional Presence | Explanation |
|---|---|
| Segment1 | The field is mandatory present in the first segment of SIB7, |
| | otherwise it is absent. |

### 5.2.2.4.9 Actions Upon Reception of SIB8

Upon receiving the SIB8 the UE shall:
1>if the SIB8 contains a complete warning message and the complete geographical area coordinates (if any):
   2>forward the received warning message, messageIdentifier, serialNumber, dataCodingScheme and the geographical area coordinates (if any) to upper layers;
   2>continue reception of SIB8;
1>else:
   2>if the received values of messageIdentifier and serialNumber are the same (each value is the same) as a pair for which a warning message and the geographical area coordinates (if any) are currently being assembled:
      3>store the received warningMessageSegment;
      3>store the received warningAreaCoordinatesSegment (if any);
      3>if all segments of a warning message and geographical area coordinates (if any) have been received:
         4>assemble the warning message from the received warningMessageSegment;
         4>assemble the geographical area coordinates from the received warningAreaCoordinatesSegment (if any);
         4>forward the received warning message, messageIdentifier, serialNumber, dataCodingScheme and geographical area coordinates (if any), countryIndication (if any) to upper layers;
         4>stop assembling a warning message and geographical area coordinates (if any) for this messageIdentifier and serialNumber and delete all stored information held for it;
      3>continue reception of SIB8;
   2>else if the received values of messageIdentifier and/or serialNumber are not the same as any of the pairs for which a warning message is currently being assembled:
      3>start assembling a warning message for this messageIdentifier and serialNumber pair;
      3>start assembling the geographical area coordinates (if any) for this messageIdentifier and serialNumber pair;
      3>store the received warningMessageSegment;
      3>store the received warningAreaCoordinatesSegment (if any);
      3>continue reception of SIB8;
         The UE should discard warningMessageSegment and warningAreaCoordinatesSegment (if any) and the associated values of messageIdentifier and serialNumber for SIB8 if the complete warning message and the geographical area coordinates (if any) have not been assembled within a period of 3 hours.
NOTE: The number of warning messages that a UE can re-assemble simultaneously is a function of UE implementation.
   SIB8
      SIB8 contains a CMAS notification.

### SIB8 Information Element

-- ASN1START
-- TAG-SIB8-START

| | |
|---|---|
| SIB8 ::= | SEQUENCE { |
| messageIdentifier | BIT STRING (SIZE (16)), |
| serialNumber | BIT STRING (SIZE (16)), |
| warningMessageSegmentType | ENUMERATED {notLastSegment, lastSegment}, |
| warningMessageSegmentNumber | INTEGER (0..63), |
| warningMessageSegment | OCTET STRING, |
| dataCodingScheme | OCTET STRING (SIZE (1)) |

OPTIONAL, -- Cond Segment1

| | |
|---|---|
| warningAreaCoordinatesSegment | OCTET STRING |

OPTIONAL, -- Need R

| | |
|---|---|
| lateNonCriticalExtension | OCTET STRING |

```
OPTIONAL,
    ...,
    country Indication OCTET STRING
}
-- TAG-SIB8-STOP
-- ASN1STOP
```

SIB8 field descriptions
dataCodingScheme
Identifies the alphabet/coding and the language applied variations of a CMAS notification.
messageIdentifier
Identifies the source and type of CMAS notification.
serialNumber
Identifies variations of a CMAS notification.
countryIndication
Identifies the country of CMAS notification.
warningAreaCoordinatesSegment
If present, carries a segment, with one or more octets, of the geographical area where the
CMAS warning message is valid as defined in [28]. The first octet of the first
warningAreaCoordinatesSegment is equivalent to the first octet of Warning Area
Coordinates IE defined in and encoded according to TS 23.041 [29] and so on.
warningMessageSegment
Carries a segment, with one or more octets, of the Warning Message Contents IE defined
in TS 38.413 [42]. The first octet of the Warning Message Contents IE is equivalent to the
first octet of the CB data IE defined in and encoded according to TS 23.041 [29], clause
9.4.2.2.5, and so on.
warningMessageSegmentNumber
Segment number of the CMAS warning message segment contained in the SIB. A segment
number of zero corresponds to the first segment, one corresponds to the second segment,
and so on. If warning area coordinates are provided for the warning message, then this
field applies to both warning message segment and warning area coordinates segment.
warningMessageSegmentType
Indicates whether the included CMAS warning message segment is the last segment or not.
If warning area coordinates are provided for the warning message, then this field applies to
both warning message segment and warning area coordinates segment.

| Conditional Presence | Explanation |
|---|---|
| Segment1 | The field is mandatory present in the first segment of SIB8, |
| | otherwise it is absent. |

### 2.2 Network Identifier Associated to PWS Message

In some aspects, a network node 104 of a network (e.g., a satellite radio access network 100) may use a network indication to indicate a network or a part of a network (e.g., one or more public land mobile networks (PLMNs), one or more tracking areas, a set of one or more cell IDs, and/or a set of one or more physical cell IDs (PCIs)) to which a PWS message is applicable. In some aspects, the network node 104 may transmit the network indication (e.g., in SI and/or in a PWS message).

In some aspects, a UE 102 may receive a network indication transmitted by a network node 104. In some aspects, the UE 102 may determine which network (or part of the network, such as a tracking area) the UE 102 is in and use the network indication to determine for network (or part of the network) the PWS message is applicable. In some aspects, if the UE determines the UE 102 to be in the network (or part of the network) for which the PWS message is applicable, the UE 102 may consider the PWS message to be applicable for the UE 102 and take appropriate actions (e.g., displaying the PWS message to the user of the UE 102). In some aspects, if the UE determines the UE 102 to not be in the network (or part of the network) for which the PWS message is applicable, the UE 102 may consider the PWS message to be not applicable for the UE 102, and the UE 102 may discard PWS message (and not display the PWS message to the user of the UE 102).

For example, an NTN-cell may span two or more countries, a PLMN may apply for one or more of the countries, at least another PLMN may apply for a different one or more of the countries, and the network indication may identify one of the PLMNs. In some aspects, a UE 102 may receive a network indication transmitted by a network node 104. In some aspects, the UE 102 may determine which PLMN the UE 102 is in and use the network indication to determine for which PLMN the PWS message is applicable. In some aspects, if the UE determines the UE 102 to be in the PLMN for which the PWS message is applicable, the UE 102 may consider the PWS message to be applicable for the UE 102 and take appropriate actions (e.g., displaying the PWS message to the user of the UE 102). In some aspects, if the UE determines the UE 102 to not be in the PLMN for which the PWS message is applicable, the UE 102 may consider the PWS message to be not applicable for the UE 102, and the UE 102 may discard PWS message (and not display the PWS message to the user of the UE 102).

In some aspects, the decision on whether to display or discard a PWS message may be performed in the AS of the UE 102 or in the NAS of the UE 102.

2.3 Area Indication within PWS Message

In some of the aspects described above, the network node 104 may provide an area indication (e.g., a country indication and/or a network indication) together with the PWS message (e.g., by providing the area indication alongside the PWS message in a system information block (SIB).

In some alternative aspects, the network node 104 may additionally or alternatively provide the area indication within the PWS message itself. In these aspects, because the area indication is provided within the PWS message itself, the area indication will be provided together with the PWS message to upper layers (e.g., the NAS layer) and that upper layer of the UE 102 can then perform the check if the UE 102 is in the area (e.g., country, network, or part of network) indicated by the area indication. In some aspects, based on the result of the check, the UE 102 may display (in case of match) or not display the PWS message (if case of mismatch).

### 2.4 Flowcharts

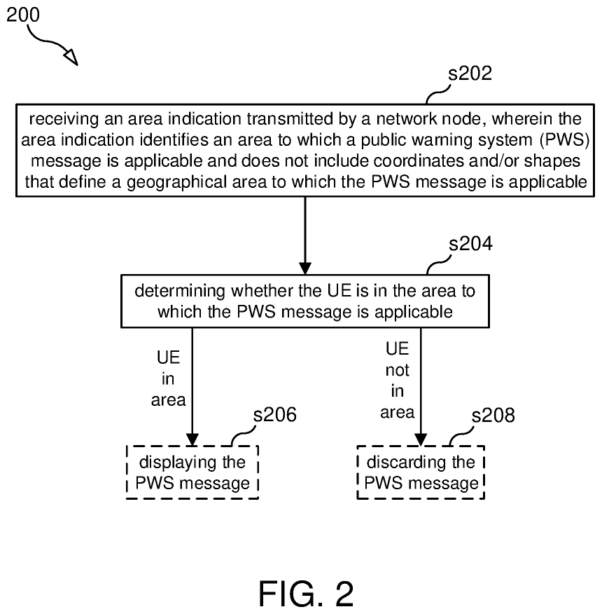

FIG. 2 illustrates a process 200 performed by a UE 102 according to some aspects. In some aspects, the process 200 may include a step 202 in which the UE 102 receives an area indication transmitted by a network node 104. In some aspects, the network node 104 may be part of a non-terrestrial network (NTN) (e.g., a satellite radio access network 100 including the network node 104, a satellite 106, a gateway 108, a feeder link, and an access link).

In some aspects, the area indication may identify an area to which a public warning system (PWS) message is applicable. In some aspects, the area indication does not include coordinates and/or shapes that define a geographical area to which the PWS message is applicable. In some aspects, the area indication may be an octet string. In some aspects, the PWS message may be an Earthquake and Tsunami Warning System (ETWS) message or a Commercial Mobile Alert System (CMAS) message. In some aspects, the area indication may be smaller than a geographical area configuration defined by a set of coordinates and/or shapes.

In some aspects, the area indication may be received in the step 202 in a Radio Resource Control (RRC) message. In some aspects, the area indication may be received in the step 202 in a system information block (SIB) (e.g., SIB6, SIB7, or SIB8) of the RRC message. In some aspects, the complete area indication may be received in a single system information block (SIB) (e.g., SIB6, SIB7, or SIB8) of the RRC message.

In some aspects, the process 200 may include a step 204 in which the UE 102 determines whether the UE 102 is in the area to which the PWS message is applicable. In some aspects, the UE 102 may use a positioning signal (e.g., a Global Navigation Satellite System (GNSS) positioning signal such as, for example and without limitation, a Global Positioning System (GPS) signal) to determine whether the UE 102 is in the area to which the PWS message is applicable.

In some aspects, the area indication received in step 202 may include a county indication that identifies a country to which the PWS message is applicable. In some aspects, determining whether the UE 102 is in the area to which the PWS message is applicable in step 204 may include the UE 102 determining whether the UE 102 is in the country to which the PWS message is applicable. In some aspects, the country indication may be a country code (e.g., “SE” for Sweden or “FI” for Finland).

In some aspects, the area indication received in step 202 may include a network indication that identifies a network or a part of a network to which the PWS message is applicable. In some aspects, determining whether the UE 102 is in the area to which the PWS message is applicable in step 204 may include the UE 102 determining whether the UE 102 is in the network or the part of the network to which the PWS message is applicable.

In some aspects, the network indication may identify one or more public land mobile networks (PLMNs) to which the PWS message is applicable, and determining whether the UE 102 is in the area to which the PWS message is applicable in step 204 may include the UE 102 determining whether the UE 102 is in the one or more PLMNs to which the PWS message is applicable. In some aspects, the network indication may identify one or more tracking areas, and determining whether the UE 102 is in the area to which the PWS message is applicable in step 204 may include the UE 102 determining whether the UE 102 is in the one or more tracking areas to which the PWS message is applicable. In some aspects, the network indication may include a set of one or more cell identifiers (IDs) that identify one or more cells to which the PWS message is applicable, and determining whether the UE 102 is in the area to which the PWS message is applicable in step 204 may include the UE 102 determining whether the UE 102 is in one of the one or more cells to which the PWS message is applicable. In some aspects, the network indication may include a set of one or more physical cell IDs (PCIs) that identify one or more physical cells to which the PWS message is applicable, and determining whether the UE 102 is in the area to which the PWS message is applicable in step 204 may include the UE 102 determining whether the UE 102 is in one of the one or more physical cells to which the PWS message is applicable.

In some aspects, the process 200 may further include an optional step 206 of the UE 102, if the UE 102 is determined in step 204 to be in the area to which the PWS message is applicable, displaying the PWS message. In some aspects, the process 200 may further include an optional step 208 of the UE 102, if the UE 102 is determined in step 204 to not be in the area to which the PWS message is applicable, discarding the PWS message. In some aspects, discarding the PWS message in the step 208 may include not displaying the PWS message.

In some aspects, the process 200 may further include an optional step in which the UE 102 receives the PWS message. In some aspects, receiving the PWS message may include receiving the PWS message or a segment of the PWS message in a system information block (SIB) of a Radio Resource Control (RRC) message, and the SIB may further include the area indication.

In some aspects, the area indication may be separate from the PWS message. In some alternative aspects, the area indication may be within the PWS message.

In some aspects (e.g., some aspects in which the area indication is separate from the PWS message), an access stratum (AS) of the UE 102 may determine in the step 204 whether the UE 102 is in the area to which the PWS message is applicable. In some aspects, the process 200 may further include an optional step in which the AS of the UE 102, if the AS determines the UE 102 to be in the area to which the PWS message is applicable in the step 204, forwards (directly or indirectly) the PWS message to an upper layer (e.g., a non-access stratum (NAS)) of the UE 102. In some aspects, if the AS determines the UE 102 to not be in the area to which the PWS message is applicable in the step 204, the AS does not forward the PWS message to an upper layer (e.g., a non-access stratum (NAS)) of the UE 102. In some aspects, the AS may be in an RRC layer of the UE 102. In some aspects, the UE 102 (e.g., the upper layer of the UE 102) may display the PWS message (e.g., in the step 206) if the AS forwards the PWS message to the upper layer. In some aspects, the AS of the UE 102 may discard the PWS message (e.g., in the step 208) if the AS does not forward the PWS message to the upper layer.

In some aspects (e.g., some aspects in which the area indication is separate from the PWS message), the method may further include an optional step in which an access stratum (AS) of the UE 102 forwards (directly or indirectly) the area indication and the PWS message to an upper layer (e.g., a non-access stratum (NAS)) of the UE 102, and the upper layer may determine in the step 204 whether the UE 102 is in the area to which the PWS message is applicable. In some aspects, the AS may be in an RRC layer of the UE 102. In some aspects, if the upper layer of the UE 102 determines the UE 102 to be in the area to which the PWS message is applicable, the UE 102 (e.g., the upper layer of the UE 102) may display the PWS message (e.g., in the step 206). In some aspects, if the upper layer of the UE 102 determines the UE 102 to not be in the area to which the PWS message is applicable, the UE 102 (e.g., the upper layer of the UE 102) may discard the PWS message (e.g., in the step 208).

In some aspects (e.g., some aspects in which the area indication is within the PWS message), the process 200 may further include an optional step in which an access stratum (AS) of the UE 102 forwards (directly or indirectly) the PWS message including the area indication to an upper layer (e.g., a non-access stratum (NAS)) of the UE 102, and the upper layer may determine in the step 204 whether the UE 102 is in the area to which the PWS message is applicable. In some aspects, the AS may be in an RRC layer of the UE 102. In some aspects, if the upper layer of the UE 102 determines the UE 102 to be in the area to which the PWS message is applicable, the UE 102 (e.g., the upper layer of the UE 102) may display the PWS message (e.g., in the step 206). In some aspects, if the upper layer of the UE 102 determines the UE 102 to not be in the area to which the PWS message is applicable, the UE 102 (e.g., the upper layer of the UE 102) may discard the PWS message (e.g., in the step 208).

In some aspects, the process 200 may further include optional steps of receiving PWS message segments and using the PWS message segments to assemble the PWS message.

In some aspects, the process 200 may further include optional steps in which the UE 102 receives coordinates and/or shapes that define a geographical area to which a second PWS message is applicable, determines whether the UE 102 is in the geographical area to which the second PWS message is applicable, and displays or discards the second PWS message based on the determination of whether the UE 102 is in the geographical area to which the second PWS message is applicable.

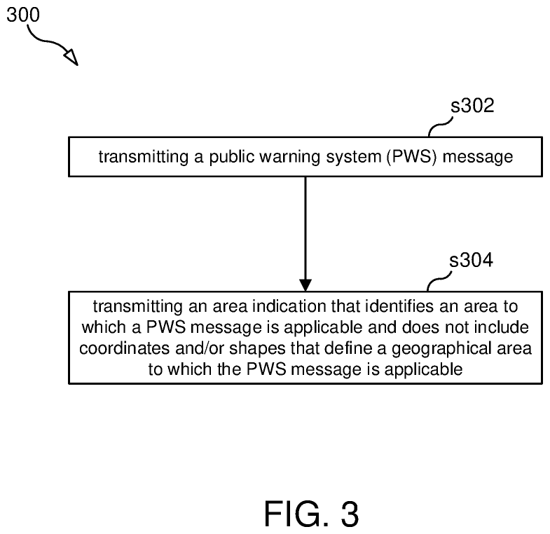

FIG. 3 illustrates a process 300 performed by a network node 104 (e.g., gNB, eNB, base station, or access node) according to some aspects. In some aspects, the network node 104 may be part of a non-terrestrial network (NTN) (e.g., a satellite radio access network 100 including the network node 104, a satellite 106, a gateway 108, a feeder link, and an access link)

In some aspects, the process 300 may include a step 302 in which the network node 104 transmits a public warning system (PWS) message. In some aspects, transmitting the PWS message in the step 302 may include transmitting PWS message segments.

In some aspects, the process 300 may include a step 304 in which the network node 104 transmits an area indication that identifies an area to which a PWS message is applicable. In some aspects, the area indication does not include coordinates and/or shapes that define a geographical area to which the PWS message is applicable.

In some aspects, the area indication may be an octet string. In some aspects, the PWS message may be an Earthquake and Tsunami Warning System (ETWS) message or a Commercial Mobile Alert System (CMAS) message. In some aspects, the area indication may be smaller than a geographical area configuration defined by a set of coordinates and/or shapes.

In some aspects, the area indication may include a county indication that identifies a country to which the PWS message is applicable. In some aspects, the country indication may be a country code.

In some aspects, the area indication may include a network indication that identifies a network or a part of a network to which the PWS message is applicable. In some aspects, the network indication may identify one or more public land mobile networks (PLMNs) to which the PWS message is applicable. In some aspects, the network indication may identify one or more tracking areas. In some aspects, the network indication may include a set of one or more cell identifiers (IDs) that identify one or more cells to which the PWS message is applicable. In some aspects, the network indication may include a set of one or more physical cell IDs (PCIs) that identify one or more physical cells to which the PWS message is applicable.

In some aspects, the area indication may be transmitted in a Radio Resource Control (RRC) message. In some aspects, the area indication may be transmitted in a system information block (SIB) (e.g., SIB6, SIB7, or SIB8) of the RRC message. In some aspects, the complete area indication may be transmitted in a single system information block (SIB) (e.g., SIB6, SIB7, or SIB8) of the RRC message.

In some aspects, transmitting the PWS message in the step 302 may include transmitting the PWS message or a segment of the PWS message in a system information block (SIB) of a Radio Resource Control (RRC) message, and the SIB may further include the area indication transmitted in the step 304.

In some aspects, the area indication may be separate from the PWS message. In some alternative aspects, the area indication may be within the PWS message.

In some aspects, the process 300 may further include optional steps in which the network node 104 transmits a second PWS message and transmits coordinates and/or shapes that define a geographical area to which the second PWS message is applicable.

### 2.5 Block Diagrams

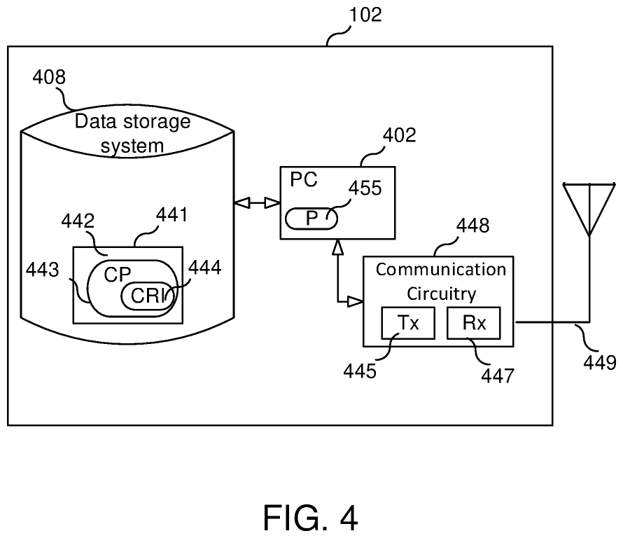

FIG. 4 is a block diagram of the UE 102, according to some aspects. As shown in FIG. 4, the UE 102 may include: processing circuitry (PC) 402, which may include one or more processors (P) 455 (e.g., one or more general purpose microprocessors and/or one or more other processors, such as an application specific integrated circuit (ASIC), field-programmable gate arrays (FPGAs), and the like); communication circuitry 448, which is coupled to an antenna arrangement 449 comprising one or more antennas and which comprises a transmitter (Tx) 445 and a receiver (Rx) 447 for enabling UE 102 to transmit data and receive data (e.g., wirelessly transmit/receive data); and a local storage unit (a.k.a., “data storage system”) 408, which may include one or more non-volatile storage devices and/or one or more volatile storage devices. In aspects where the PC 402 includes a programmable processor, a computer program product (CPP) 441 may be provided. In some aspects, the CPP 441 may include a computer readable medium (CRM) 442 storing a computer program (CP) 443 including computer readable instructions (CRI) 444. In some aspects, the CRM 442 may be a non-transitory computer readable medium, such as, magnetic media (e.g., a hard disk), optical media, memory devices (e.g., random access memory, flash memory), and the like. In some aspects, the CRI 444 of computer program 443 may be configured such that, when executed by PC 402, the CRI causes UE 102 to perform steps described herein (e.g., steps described herein with reference to the flow charts). In other aspects, the UE 102 may be configured to perform steps described herein without the need for code. That is, for example, the PC 402 may consist merely of one or more ASICs. Hence, the features of the aspects described herein may be implemented in hardware and/or software.

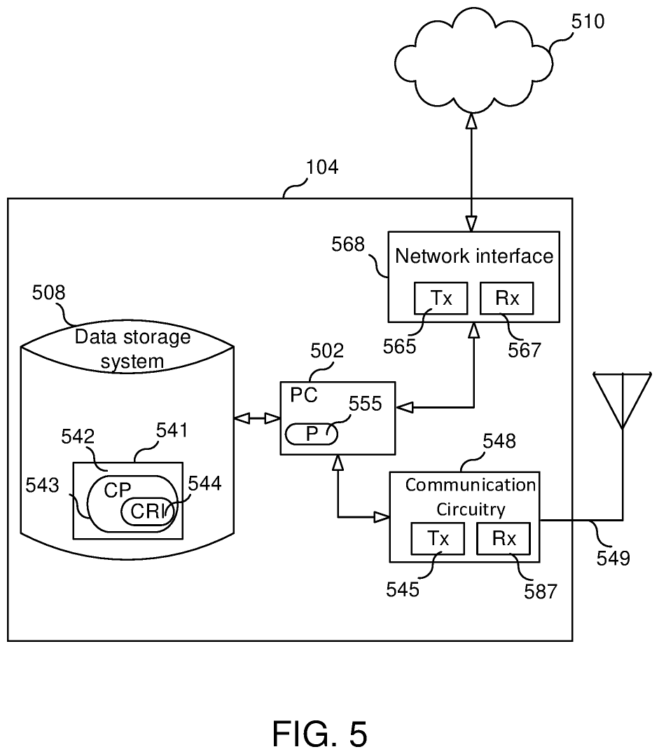

FIG. 5 is a block diagram of network node 104 (e.g., gNB, eNB, base station, or access node), according to some aspects, that can be used to implement any one of the network functions described herein. As shown in FIG. 5, the network node 104 may include: processing circuitry (PC) 502, which may include one or more processors (P) 555 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 104 may be a distributed computing apparatus); at least one network interface 548 (e.g., a physical interface or air interface) comprising a transmitter (Tx) 545 and a receiver (Rx) 547 for enabling network node 104 to transmit data to and receive data from other nodes connected to a network 510 (e.g., an Internet Protocol (IP) network) to which network interface 548 is connected (physically or wirelessly) (e.g., network interface 548 may be coupled to an antenna arrangement comprising one or more antennas for enabling network node 104 to wirelessly transmit/receive data); and a local storage unit (a.k.a., “data storage system”) 508, which may include one or more non-volatile storage devices and/or one or more volatile storage devices. In some aspects where the PC 502 includes a programmable processor, a computer program product (CPP) 541 may be provided. In some aspects, the CPP 541 may include a computer readable medium (CRM) 542 storing a computer program (CP) 543 including computer readable instructions (CRI) 544. In some aspects, the CRM 542 may be a non-transitory computer readable medium, such as, magnetic media (e.g., a hard disk), optical media, memory devices (e.g., random access memory, flash memory), and the like. In some aspects, the CRI 544 of computer program 543 may be configured such that, when executed by the PC 502, the CRI 544 causes the network node 104 to perform steps described herein (e.g., steps described herein with reference to the flow charts). In some other aspects, the network node 104 may be configured to perform steps described herein without the need for code. That is, for example, the PC 502 may consist merely of one or more ASICs. Hence, the features of the embodiments described herein may be implemented in hardware and/or software.

### Summary of Embodiments

A1. A method (200) performed by a user equipment (UE) (102), the method comprising: receiving an area indication transmitted by a network node (104), wherein the area indication identifies an area to which a public warning system (PWS) message is applicable and does not include coordinates and/or shapes that define a geographical area to which the PWS message is applicable; and determining whether the UE is in the area to which the PWS message is applicable.

A2. The method of embodiment A1, wherein the area indication is an octet string.

A3. The method of embodiment A1 or A2, wherein the PWS message is an Earthquake and Tsunami Warning System (ETWS) message or a Commercial Mobile Alert System (CMAS) message.

A4. The method of any one of embodiments A1-A3, wherein the area indication is smaller than a geographical area configuration defined by a set of coordinates and/or shapes.

A5. The method of any one of embodiments A1-A4, wherein the area indication includes a county indication that identifies a country to which the PWS message is applicable, and determining whether the UE is in the area to which the PWS message is applicable comprises determining whether the UE is in the country to which the PWS message is applicable.

A6. The method of embodiment A5, wherein the country indication is a country code.

A7. The method of any one of embodiments A1-A6, wherein the area indication includes a network indication that identifies a network or a part of a network to which the PWS message is applicable, and determining whether the UE is in the area to which the PWS message is applicable comprises determining whether the UE is in the network or the part of the network to which the PWS message is applicable.

A8. The method of embodiment A7, wherein the network indication identifies one or more public land mobile networks (PLMNs) to which the PWS message is applicable, and determining whether the UE is in the area to which the PWS message is applicable comprises determining whether the UE is in the one or more PLMNs to which the PWS message is applicable.

A9. The method of embodiment A7 or A8, wherein the network indication identifies one or more tracking areas, and determining whether the UE is in the area to which the PWS message is applicable comprises determining whether the UE is in the one or more tracking areas to which the PWS message is applicable.

A10. The method of any one of embodiments A7-A9, wherein the network indication includes a set of one or more cell identifiers (IDs) that identify one or more cells to which the PWS message is applicable, and determining whether the UE is in the area to which the PWS message is applicable comprises determining whether the UE is in one of the one or more cells to which the PWS message is applicable.

A11. The method of any one of embodiments A7-A10, wherein the network indication includes a set of one or more physical cell IDs (PCIs) that identify one or more physical cells to which the PWS message is applicable, and determining whether the UE is in the area to which the PWS message is applicable comprises determining whether the UE is in one of the one or more physical cells to which the PWS message is applicable.

A12. The method of any one of embodiments A1-A11, further comprising, if the UE is determined to be in the area to which the PWS message is applicable, displaying the PWS message.

A13. The method of any one of embodiments A1-A11, further comprising, if the UE is determined to not be in the area to which the PWS message is applicable, discarding the PWS message.

A14. The method of embodiment A13, wherein discarding the PWS message comprises not displaying the PWS message.

A15. The method of any one of embodiments A1-A14, wherein the area indication is received in a Radio Resource Control (RRC) message.

A16. The method of embodiment A15, wherein the area indication is received in a system information block (SIB) (e.g., SIB6, SIB7, or SIB8) of the RRC message.

A17. The method of embodiment A15 or A16, wherein the complete area indication is received in a single system information block (SIB) (e.g., SIB6, SIB7, or SIB8) of the RRC message.

A18. The method of any one of embodiments A1-A17, further comprising receiving the PWS message.

A19. The method of embodiment A18, wherein receiving the PWS message comprises receiving the PWS message or a segment of the PWS message in a system information block (SIB) of a Radio Resource Control (RRC) message, and the SIB further includes the area indication.

A20. The method of any one of embodiments A1-A19, wherein the area indication is separate from the PWS message.

A21. The method of any one of embodiments A1-A20, wherein an access stratum (AS) of the UE determines whether the UE is in the area to which the PWS message is applicable.

A22. The method of embodiment A21, further comprising, if the AS determines the UE to be in the area to which the PWS message is applicable, the AS forwarding the PWS message to an upper layer (e.g., a non-access stratum (NAS)) of the UE.

A23. The method of embodiment A21, further comprising, if the AS determines the UE to not be in the area to which the PWS message is applicable, the AS does not forward the PWS message to an upper layer (e.g., a non-access stratum (NAS)) of the UE.

A24. The method of any one of embodiments A21-A23, wherein the AS is an RRC layer of the UE.

A25. The method of any one of embodiments A1-A20, further comprising an access stratum (AS) of the UE forwarding the area indication and the PWS message to an upper layer (e.g., a non-access stratum (NAS)) of the UE, wherein the upper layer determines whether the UE is in the area to which the PWS message is applicable.

A26. The method of any one of embodiments A1-A18, wherein the area indication is within the PWS message.

A27. The method of embodiment A26, further comprising an access stratum (AS) of the UE forwarding the PWS message including the area indication to an upper layer (e.g., a non-access stratum (NAS)) of the UE, wherein the upper layer determines whether the UE is in the area to which the PWS message is applicable.

A28. The method of any one of embodiments A1-A27, further comprising receiving PWS message segments and using the PWS message segments to assemble the PWS message.

B1. A computer program (443) comprising instructions (444) which, when executed by processing circuitry (402) of a user equipment (UE) (102), cause the UE (102) to perform the method of any one of embodiments A1-A28.

B2. A carrier containing the computer program of embodiment B1, wherein the carrier is one of an electronic signal, an optical signal, a radio signal, and a computer readable storage medium (442).

C1. A user equipment (UE) (102), the UE comprising: processing circuitry (402); and a memory (442), the memory containing instructions (444) executable by the processing circuitry, whereby the UE is configured to perform the method of any one the embodiments A1-A28.

D1. A user equipment (UE) (102), the UE being configured to: receive an area indication transmitted by a network node (104), wherein the area indication identifies an area to which a public warning system (PWS) message is applicable and does not include coordinates and/or shapes that define a geographical area to which the PWS message is applicable; and determine whether the UE is in the area to which the PWS message is applicable.

D2. The UE of embodiment D1, wherein the UE is further configured to perform the method of any one of claims A2-A28.

E1. A method performed by a network node (104) (e.g., gNB, eNB, base station, or access node), the method comprising: transmitting a public warning system (PWS) message; and transmitting an area indication that identifies an area to which a PWS message is applicable and does not include coordinates and/or shapes that define a geographical area to which the PWS message is applicable.

E2. The method of embodiment E1, wherein the area indication is an octet string.

E3. The method of embodiment E1 or E2, wherein the PWS message is an Earthquake and Tsunami Warning System (ETWS) message or a Commercial Mobile Alert System (CMAS) message.

E4. The method of any one of embodiments E1-E3, wherein the area indication is smaller than a geographical area configuration defined by a set of coordinates and/or shapes.

E5. The method of any one of embodiments E1-E4, wherein the area indication includes a county indication that identifies a country to which the PWS message is applicable.

E6. The method of embodiment E5, wherein the country indication is a country code.

E7. The method of any one of embodiments E1-E6, wherein the area indication includes a network indication that identifies a network or a part of a network to which the PWS message is applicable.

E8. The method of embodiment E7, wherein the network indication identifies one or more public land mobile networks (PLMNs) to which the PWS message is applicable.

E9. The method of embodiment E7 or E8, wherein the network indication identifies one or more tracking areas.

E10. The method of any one of embodiments E7-E9, wherein the network indication includes a set of one or more cell identifiers (IDs) that identify one or more cells to which the PWS message is applicable.

E11. The method of any one of embodiments E7-E10, wherein the network indication includes a set of one or more physical cell IDs (PCIs) that identify one or more physical cells to which the PWS message is applicable.

E12. The method of any one of embodiments E1-E11, wherein the area indication is transmitted in a Radio Resource Control (RRC) message.

E13. The method of embodiment E12, wherein the area indication is transmitted in a system information block (SIB) (e.g., SIB6, SIB7, or SIB8) of the RRC message.

E14. The method of embodiment E12 or E13, wherein the complete area indication is transmitted in a single system information block (SIB) (e.g., SIB6, SIB7, or SIB8) of the RRC message.

E15. The method of any one of embodiments E1-E14, wherein transmitting the PWS message comprises transmitting the PWS message or a segment of the PWS message in a system information block (SIB) of a Radio Resource Control (RRC) message, and the SIB further includes the area indication.

E16. The method of any one of embodiments E1-E15, wherein the area indication is separate from the PWS message.

E17. The method of any one of embodiments E1-E15, wherein the area indication is within the PWS message.

E18. The method of any one of embodiments E1-E17, wherein transmitting the PWS message comprises transmitting PWS message segments.

F1. A computer program (543) comprising instructions (544) which, when executed by processing circuitry (502) of a network node (104) (e.g., gNB, eNB, base station, or access node), cause the network node to perform the method of any one of embodiments E1-E18.

F2. A carrier containing the computer program of embodiment F1, wherein the carrier is one of an electronic signal, an optical signal, a radio signal, and a computer readable storage medium (542).

G1. A network node (104) (e.g., gNB, eNB, base station, or access node), the network node comprising: processing circuitry (502); and a memory (542), the memory containing instructions (544) executable by the processing circuitry, whereby the network node is configured to perform the method of any one the embodiments E1-E18.

H1. A network node (104) (e.g., gNB, eNB, base station, or access node), the network node being configured to: transmit a public warning system (PWS) message; and transmit an area indication that identifies an area to which a PWS message is applicable and does not include coordinates and/or shapes that define a geographical area to which the PWS message is applicable.

H2. The network node of embodiment H1, wherein the network node is further configured to perform the method of any one of claims E2-E18.

I1. Any combination of the embodiments set forth above.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. For example, as the area indication may be within the PWS message and/or in the same system information block as the PWS message (or segment thereof), steps 402 and 404 of the process 400 may be performed in parallel.

1. A method performed by a user equipment (UE), the method comprising:
receiving an area indication transmitted by a network node, wherein the area indication identifies an area to which a public warning system (PWS) message is applicable and does not include coordinates and/or shapes that define a geographical area to which the PWS message is applicable; and
determining whether the UE is in the area to which the PWS message is applicable.

2. (canceled)

3. The method of claim 1, wherein the PWS message is an Earthquake and Tsunami Warning System (ETWS) message or a Commercial Mobile Alert System (CMAS) message.

4. The method of claim 1, wherein the area indication is smaller than a geographical area configuration defined by a set of coordinates and/or shapes.

5. The method of claim 1, wherein the area indication includes a county indication that identifies a country to which the PWS message is applicable, and determining whether the UE is in the area to which the PWS message is applicable comprises determining whether the UE is in the country to which the PWS message is applicable.

6. The method of claim 1, wherein the area indication includes a network indication that identifies a network or a part of a network to which the PWS message is applicable, and determining whether the UE is in the area to which the PWS message is applicable comprises determining whether the UE is in the network or the part of the network to which the PWS message is applicable.

7. The method of claim 6, wherein the network indication identifies one or more public land mobile networks (PLMNs) to which the PWS message is applicable, and determining whether the UE is in the area to which the PWS message is applicable comprises determining whether the UE is in the one or more PLMNs to which the PWS message is applicable.

8. The method of claim 6, wherein the network indication identifies one or more tracking areas, and determining whether the UE is in the area to which the PWS message is applicable comprises determining whether the UE is in the one or more tracking areas to which the PWS message is applicable.

9. The method of claim 6, wherein the network indication includes a set of one or more cell identifiers (IDs) that identify one or more cells to which the PWS message is applicable, and determining whether the UE is in the area to which the PWS message is applicable comprises determining whether the UE is in one of the one or more cells to which the PWS message is applicable.

10. The method of claim 6, wherein the network indication includes a set of one or more physical cell IDs (PCIs) that identify one or more physical cells to which the PWS message is applicable, and determining whether the UE is in the area to which the PWS message is applicable comprises determining whether the UE is in one of the one or more physical cells to which the PWS message is applicable.

11. The method of claim 1, further comprising, if the UE is determined to be in the area to which the PWS message is applicable, displaying the PWS message.

12. (canceled)

13. The method of claim 1, wherein the area indication is received in a system information block (SIB) of a Radio Resource Control (RRC) message.

14. (canceled)

15. (canceled)

16. The method of claim 1, further comprising receiving the PWS message, wherein receiving the PWS message comprises receiving the PWS message or a segment of the PWS message in a system information block (SIB) of a Radio Resource Control (RRC) message, and the SIB further includes the area indication.

17. (canceled)

18. The method of claim 1, wherein an access stratum (AS) of the UE determines whether the UE is in the area to which the PWS message is applicable, and the method further comprises, if the AS determines the UE to be in the area to which the PWS message is applicable, the AS forwarding the PWS message to an upper layer of the UE.

19-23. (canceled)

24. The method of claim 1, further comprising receiving two or more message segments and assembling the message segments to obtain the PWS message.

25. A user equipment (UE), the UE being configured to:
receive an area indication transmitted by a network node, wherein the area indication identifies an area to which a public warning system (PWS) message is applicable and does not include coordinates and/or shapes that define a geographical area to which the PWS message is applicable; and
determine whether the UE is in the area to which the PWS message is applicable.

26. A method performed by a network node, the method comprising:
transmitting a public warning system (PWS) message; and
transmitting an area indication that identifies an area to which a PWS message is applicable and does not include coordinates and/or shapes that define a geographical area to which the PWS message is applicable.

27. (canceled)

28. The method of claim 26, wherein the PWS message is an Earthquake and Tsunami Warning System (ETWS) message or a Commercial Mobile Alert System (CMAS) message.

29. The method of claim 26, wherein the area indication is smaller than a geographical area configuration defined by a set of coordinates and/or shapes.

30. The method of claim 26, wherein the area indication includes a county indication that identifies a country to which the PWS message is applicable.

31. The method of claim 26, wherein the area indication includes a network indication that identifies a network or a part of a network to which the PWS message is applicable.

32. The method of claim 31, wherein the network indication identifies one or more public land mobile networks (PLMNs) to which the PWS message is applicable.

33. (canceled)

34. The method of claim 31, wherein the network indication includes one or more of: a set of one or more cell identifiers (IDs) that identify one or more cells to which the PWS message is applicable, a set of one or more physical cell IDs (PCIs) that identify one or more physical cells to which the PWS message is applicable, and a set of one or more identifiers to identify one or more tracking areas to which the PWS message is applicable.

35. (canceled)

36. The method of claim 26, wherein the area indication is transmitted in a system information block (SIB) of a Radio Resource Control (RRC) message.

37. (canceled)

38. (canceled)

39. The method of claim 26, wherein transmitting the PWS message comprises transmitting the PWS message or a segment of the PWS message in a system information block (SIB) of a Radio Resource Control (RRC) message, and the SIB further includes the area indication.

40. A network node, the network node being configured to:
transmit a public warning system (PWS) message; and
transmit an area indication that identifies an area to which a PWS message is applicable and does not include coordinates and/or shapes that define a geographical area to which the PWS message is applicable.

41. The network node of claim 40, comprising:
processing circuitry; and
a memory containing instructions executable by said processing circuitry, whereby said network node is operative to transmit the PWS message and the area indication.

42. The UE of claim 25, comprising:
processing circuitry; and
a memory containing instructions executable by said processing circuitry, whereby said UE is operative to receive the area indication and determine whether the UE is in the area to which the PWS message is applicable.
